(19) United States
(12) Patent Application Publication
(10) Pub. No.: US 2016/0120164 A1
(43) Pub. Date: May 5, 2016

(54) Stick-trap type trap for tobacco pests

(71) Applicant: WUHAN DONGCHANG STORAGE TECH CO., LTD, Wuhan (CN)

(72) Inventor: Yiwei Li, Wuhan (CN)

(73) Assignee: WUHAN DONGCHANG STORAGE TECH CO., LTD

(21) Appl. No.: 14/993,593

(22) Filed: Jan. 12, 2016

(30) Foreign Application Priority Data
Feb. 27, 2015 (CN) 201510089627.3

(51) Int. Cl. A01M 1/14; A01M 1/02

(52) U.S. Cl. CPC A01M 1/14; A01M 1/023; A01M 1/026

(57) ABSTRACT

A stick-trap type trap for tobacco pests includes a bottom plate, a face plate, a glue for sticking pests and a lure containing tobacco pest pheromones. The bottom plate is engaged with the face plate. A trapping cavity is formed between the bottom plate and the face plate. A side surface of the trapping cavity is communicated with an internal environment. The glue is coated on an internal surface of the bottom plate opposite to the face surface. The lure is located on the internal surface of the bottom plate. The face plate is made of materials as follows: (A) transparent materials or magnifying lens materials with the function of increasing visual angle; (B) non-transparent sheet materials, wherein an observation hole is provided on the face plate, a transparent dust-proof board is inserted into the observation hole for observing an amount of trapped pests.

### CROSS REFERENCE OF RELATED APPLICATION

The present invention claims priority under 35 U.S.C. 119(a-d) to CN 201510089627.3, filed Feb. 27, 2015.

### BACKGROUND OF THE PRESENT INVENTION

1. Field of Invention

The present invention relates to a stick-trap type trap for tobacco pests, and more particularly to a trap for tobacco pests which is convenient for intuitively and accurately counting.

2. Description of Related Arts

Due to tobacco beetles and moth harms, the tobacco reservoir loss worldwide each year is approximately 1% of tobacco production, equivalent to about $3 billion in economic losses. In China, due to tobacco pests, an average weight loss of the tobacco is about 1.64 percent, the tobacco pests directly eating the tobacco bring the loss of tobacco and products thereof, the economic losses are 2-400 million RMB. Under the harm of the tobacco pests, the tobacco processing silk rate falls 3.5% to 4.5%; the portions of the tobacco damaged by the pests needs manual cleaning, which increases the cost; the pests leave dead bodies and excrements in the boxes or bags, which seriously pollutes the tobacco, the quality of the tobacco is reduced; simultaneously, the healthy of consumers and the reputation of cigarette brand are also affected. Furthermore, during the tobacco processing, three main links including tobacco-redrying, tobacco-storage and tobacco-production have the risk of suffering the serious harm from the tobacco pests. The trap for tobacco pests is needed to monitor the pest situation in the processing region, so as to timely control the pest situation in the processing region to provide data support for preventing and controlling the pests and simultaneously greatly reduce the harm density.

The current traps for tobacco pests on the market depend on the tobacco pest pheromones to trap combined with the strong sticking-pest boards to capture the pests. Various traps generally adopt non-transparent paper materials as the carrier of the adhesive layer of the traps. While using, the amount of the trapped tobacco pests is counted by manually opening and observing every trap. After using, the trap is recovered and then hung in situ. This operational mode limits the working efficiency of monitoring and recording. For areas where more traps are placed or where traps are highly hung, the monitoring and recording operation is complex and has low efficiency.

China Patent No. 201020529840.4 disclosed a trap for tobacco pests which is convenient for observing and dust-proofing. However, while using, the disclosed trap needs cooperating with the protective box. Firstly, it needs installing an independently transparent protective box, and then the protective layer of the single-layer adhesive board is uncovered and inserted into the protective box. During practical applications, it is easy for the protective box to be damaged by tobacco packing cases or cleaning tools, so that the protective box needs continuously replacing, which results in high cost. Therefore, the disclosed trap has a limitation in practical applications. If the above mentioned transparent protective box is not cooperated with the trap, the monolithic trap for tobacco pests separately used is hard to spread due to lack of dust-proof function, and is unable to be used under the workshop environment of the cigarette factory having dust and floating debris.

While applying the trap for tobacco pests, disclosed by China Patent No. 201020529840.4, to monitor the pest situation in the sealing tobacco stacking, the protective box needs to be fixed on the tobacco packing case. When the tobacco enters the cigarette factory, the protective box along with the tobacco packing case also enter the cigarette factory, so that industrial impurities are formed, thereby the production is interfered. Furthermore, the tent needs to be disassembled while checking the trap in the stacking sealing tent every time for opening the protective box of the trap and replacing the monolithic trap. Therefore, the trap has lower replacing efficiency.

The more critical issues are: (1) tobacco beetles like taking actions in shadows and gaps, have small sizes, particularly tobacco beetle adults have small sizes with a body length of 2.0 mm or so, the adults are reddish brown which is similar to the color of tobacco detritus; (2) the trap is generally hung in the workshop and the tobacco warehouse of the cigarette factory, these situations have a large floating amount of tobacco detritus, the glue surface of the trap is easy to attach some floating tobacco detritus and fragments while trapping the pests, the floating tobacco detritus and fragments have similar shape and color with the tobacco pests, which often interferences normally manual counting, thereby resulting in large counting errors.

The traps for tobacco pests on the market or disclosed by China Patent No. 201020529840.4 have the above mentioned problem that the traps are difficult to exclude the counting accuracy affected by the impurity interferences, which greatly affects the working efficiency and quality of the operator on the first line.

Furthermore, in the raps for tobacco pests, which are convenient for observing and dust-proofing, disclosed by China Patent No. 201020529840.4, the cooperated protective box is made of hard plastics or glass, the face plate of the protective box is unable to be bent, which also limits the application range of the trap, thereby it is not conductive for the trap to be applied to the occasions with narrow spaces.

### SUMMARY OF THE PRESENT INVENTION

A technical problem to be resolved by the present invention is to provide a stick-trap type trap for tobacco pests with simple structure, without manual operation and protective box, and capable of intuitively and accurately observing, and counting in front of the trap.

To resolve the above mentioned technical problem, a technical solution adopted by the present invention is as follows:

A stick-trap type trap for tobacco pests, comprises: a bottom plate 1, a face plate 2, a glue 3 for sticking pests and a lure 4 containing tobacco pest pheromones; wherein both the bottom plate 1 and the face plate 2 are made of bendable plastic sheet or Kraft Linerboard (KLB) with a weight index of over 120 g/m², the face plate 2 is bent for engaging with the bottom plate 1 to form a trapping cavity 11 with a side face which is 1( )communicated with a surrounding environment of the trap (specifically, a left side face or a right side face of the trapping cavity 11 is communicated with the surrounding environment of the trap, or both the left side face and the right side face are communicated with the surrounding environment of the trap, or holes, cracks or gaps are provided on a side face of the trapping cavity 11 for allowing the tobacco pests to enter the trapping cavity 11), the glue 3 for sticking pests is coated on an internal surface of the bottom plate 1 which is located within the trapping cavity 11 and is opposite to the face plate 2, the lure 4 containing tobacco pest pheromones is located on the internal surface of the bottom plate 1 or the face plate 2 which are located within the trapping cavity 11 (namely, the lure 4 for releasing tobacco insect attractant is located on the glue 3 for sticking pests, the glue 3 for sticking pests and the lure 4 are located within the trapping cavity 11).

The face plate is made of materials as follows.
(A) The face plate is made of transparent materials.
(B) The face plate is made of non-transparent flaky materials (the bottom plate is also able to be made of non-transparent flaky materials), an observation hole is provided on the face plate, a transparent dust-proof board 9 is inserted into or attached to the observation hole for observing an amount of trapped pests, the transparent dust-proof board 9 is made of transparent materials or magnifying lens materials with image zoom function.
(C) The face plate 2 is made of magnifying lens materials with image zoom function (To improve the observation and identification effect of the amount of the tobacco pests, the face plate 2 of the trap is made of magnifying lens materials with the function of increasing visual angle).

Two bottom plate block buttons (namely, a bottom plate upper block button 6 and a bottom plate lower block button 8) for mounting the face plate 2 are respectively located at a middle portion of an upper edge and a lower edge of the bottom plate 1. The bottom plate 1 and the face plate 2 are designed to two parts independent from each other. Two face plate block buttons (namely, a face plate upper block button 5 and a face plate lower block button 7) for engaging with the two bottom plate block buttons are respectively located at a middle portion of an upper edge and a lower edge of the face plate 2 which is opposite to the bottom plate 1. While using, the face plate 2 is bent to respectively engage the two face plate block buttons with the two bottom plate block buttons.

The upper edge and the lower edge of the bottom plate or the face plate refer to two edges which are symmetrical to each other of the bottom plate or the face plate with a certain planar polygon shape. If one of the two edges is called as the upper edge, the other which is symmetrical to the one is called as the lower edge. Generally, the trap vertically faces the view of an operator. An edge located at an upper portion of the bottom (face) plate in the view of the operator is called as the upper edge of the bottom (face) plate. An edge located at a lower portion of the bottom (face) plate in the view of the operator is called as the lower edge of the bottom (face) plate (referring to FIGS. 1-4, number “5” refers to a block button located at a middle portion of the upper edge of the face plate, number “6” refers to a block button located at a middle portion of the upper edge of the bottom plate, number “7” refers to a block button located at a middle portion of the lower edge of the face plate, number “8” refers to a block button located at a middle portion of the lower edge of the bottom plate).

The bottom plate block buttons are foldable block buttons manufactured by cutting the middle portion of the upper edge or the lower edge of the bottom plate of the trap through the stamping or die-cutting process (referring to number “6” and number “8” in FIGS. 1 and 3 and number “6” in FIGS. 2 and 4). Similarly, the face plate block buttons, capable of engaging with the bottom plate block buttons, are manufactured by cutting the middle portion of the upper edge or the lower edge of the face plate of the trap through the stamping or die-cutting process (referring to number “5” and number “7” in FIGS. 1 and 3 and number “5” in FIGS. 2 and 4).

The bottom plate and the face plate are integrated (namely, the bottom plate and the face plate are directly designed to be a whole, or the bottom plate is bonded or hotly combined with the face plate to be a whole). A broken line 10 is provided at a middle of an integrated structure formed by the bottom plate 1 and the face plate 2. The integrated structure formed by the bottom plate 1 and the face plate 2 is folded in half along the broken line 10. Meanwhile, two block buttons (namely, the bottom plate upper block button 6 and the face plate upper block button 5) are respectively located at the middle portion of the upper edge of the bottom plate and the face plate. While using, the face plate is bent to engage the face plate upper block button 5 with the bottom plate upper block button 6.

A planar polygon shape of the face plate 2 is similar to that of the bottom plate 1.

The face plate is a flaky arched plate (which is arched after bending, as shown in FIGS. 1, 2-1, 3 and 4), or the face plate is a planar plate with two broken lines (wherein the two broken lines are respectively provided at two ends of the face plate, the face plate is bent along the two broken lines for allowing the bent face plate to connected with the bottom plate, the face plate and the bottom plate keep a relatively horizontal state at this time), or the face plate is a spherical plate (with a structure similar to FIGS. 1, 2-1, 3 and 4, only the face plate is stamped to be spherical).

While using, the trap of the present invention is placed at regions where the tobacco pests may appear. The trap of the present invention is capable of intuitively and accurately observing, and counting the amount of trapped tobacco pests from the front of the trap without opening the face plate of the trap.

Compared with the prior art, the prominent substantive features and notable progress of the present invention are as follows.
(1) The face plate of the stick-trap type trap is made of transparent flaky materials, which not only plays a role in protecting the glue of the trap, but also achieves an intuitive and transparent glue surface of the trap, such that the amount of the trapped tobacco pests is intuitively and accurately observed by the transparent face plate of the trap without the protective box, thereby avoiding assembling the protective box and saving the cost.

Both the bottom plate and the face plate are made of bendable plastic sheet or Kraft Linerboard (KLB) with a weight index of over 120 g/m², such that the face plate of the trap is bendable for engaging with the bottom plate block buttons. The bendable face plate also improves the applicability of the trap.
(2) The trap of the present invention resolves the problem that the trap made of non-transparent materials needs manual operation to open the face plate for observing the amount of the tobacco pests. Therefore, the monitoring operation is more convenient and simple.
(3) The face plate of the trap is made of magnifying lens materials, such that shapes and sizes of the trapped tobacco pests on the glue surface of the trap are magnified for better excluding interferences of various foreign bodies mixed on the glue surface to the vision of the observer, thereby greatly reducing the counting error.
(4) The problems encountered when the trap is applied to the interior of plastic tent sealing tobacco stacking are resolved. No protective box is needed to be hung above the smoke box adapted for sealing tobacco stacking, which not only resolves the difficulty that when the tobacco enter the cigarette factory, the protective box along with the tobacco packing case also enter the cigarette factory, so that the production is interfered. Furthermore, the tent doesn't need to open while checking, the operator is able to stand outside the sealing tent for directly observing and recording the amount of the trapped pests, thereby greatly improving the work efficiency.
(5) The face plate and the bottom plate of the trap are separately designed. The face plate with transparent or magnifier function is able to be repeatedly used, and only the lure and the bottom plate which is coated with the glue need to be regularly replaced, thereby greatly saving the procurement cost of the trap.

The transparent flaky materials adopted by the present invention are soft, thin flaky plastic materials, such as PA materials, PP materials, PVC materials, PET materials, ARM materials, BOPP materials, CPP materials, LDPE materials and glass paper. The magnifying lens materials with the function of increasing visual angle are PVC transparent magnifying lens or thin glass magnifying lens. The non-transparent flaky materials are plastic sheets, or non-transparent papers made of plants.

The lure containing tobacco pest pheromones is provided at a middle of a trapped surface, the tobacco pest pheromones added to the lure are able to lure the tobacco pests to enter the trapping region, thereby improving the trapping efficiency.

The lure capable of releasing tobacco pest attractant adopted by the present invention is the lure containing tobacco pest pheromones which is produced by Dongchang Warehousing Technology Limited Company, Wuhan, China. The component of the tobacco beetle pheromones is (4s, 6s, 7s)-7-hydroxy-4, 6-dimethyl-3-nonanone, the component of the tobacco almond moth pheromones is (Z, E) 9, 12-tetradecadiene-1-alcohol acetate, or (E)-phytol (3, 7, 11, 15-tetramethyl-2-hexadecene ethanol).

The glue adopted by the present invention is a light-yellow or colorless, odorless, non-toxic, non-corrosive, non-residual semi-transparent liquid. Its period of validity is four months or more, and has good UV resistance and weathering resistance performances. In the present invention, the release paper (which is also called as silicone paper with high temperature resistance, moisture proof and oil proof function for isolative protecting the glue) is attached on the glue for sticking pests.

The present invention has simple structure, no manual operation and protective box are needed, thereby intuitively and accurately observing and counting in front of the trap.

These and other objectives, features, and advantages of the present invention will become apparent from the following detailed description, the accompanying drawings, and the appended claims.

### BRIEF DESCRIPTION OF THE DRAWINGS

Fig. 1 is a perspective view of a split-type trap of the present invention, wherein both a bottom plate and a face plate are made of transparent materials (or magnifying lens materials comprising PVC and glass).

FIG. 2-1 is perspective view of an integrated trap of the present invention, wherein both a bottom plate and a face plate are made of transparent materials (or magnifying lens materials comprising PVC and glass).

FIG. 2-2 is a planar structural view of the integrated trap of the present invention, wherein both the bottom plate and the face plate are made of transparent materials (or magnifying lens materials comprising PVC and glass).

FIG. 3 is a perspective view of a split-type trap of the present invention, wherein the trap is made of non-transparent flaky materials, a transparent dust-proof board (or magnifying lens materials comprising PVC and glass) is inserted into a middle of a face plate.

FIG. 4 is a perspective view of an integrated trap of the present invention, wherein the trap is made of non-transparent flaky materials, a transparent dust-proof board (or called as transparent sheets, or magnifying lens materials comprising PVC and glass) is inserted into a middle of a face plate.

FIG. 5 is a sectional view of FIG. 1 along A-A.

In the drawings: 1-bottom plate; 2-face plate; 3-glue for sticking pests (industrial glue for sticking pests); 4-lure containing tobacco pest pheromones (lure containing tobacco pest attractant); 5-face plate upper block button; 7-face plate lower block button; 6-bottom plate upper block button; 8-bottom plate lower block button; 9-transparent dust-proof board (or made of magnifying lens materials comprising PVC and glass); 10-broken line; 11-trapping cavity.

### DETAILED DESCRIPTION OF THE PREFERRED EMBODIMENT

Referring to FIGS. 1 and 5 of the drawings (split-type trap), a stick-trap type trap for tobacco pests according to a preferred embodiment of the present invention is illustrated, comprising a bottom plate 1, a face plate 2, a glue 3 for sticking pests, and a lure 4 containing tobacco pest pheromones; wherein the bottom plate 1 is made of plastic sheet or Kraft Linerboard (KLB), the face plate 2 is made of transparent materials (comprising PVC plastics, Acrylic plastics, ABS plastics and glass); the bottom plate 1 and the face plate 2 are designed to be independent from each other, the face plate 2 is located above the bottom plate 1; the face plate 2 is bent for engaging with the bottom plate 1 to form a trapping cavity 11 with a side face which is communicated with a surrounding environment of the trap; the side face (which can be a left side face, a right side face, or both, wherein the side face is an opening end convenient for allowing the tobacco pests to enter the trapping cavity) of the trapping cavity 11 is communicated with an external (wherein the side face is an opening end convenient for allowing the tobacco pests to enter the trapping cavity); an industrial glue for sticking pests is coated on an internal surface of the bottom plate 1 within the trapping cavity 11 and opposite to the face plate 2 (wherein a layer of release paper with smooth surface is attached on a layer of the industrial glue for protecting the layer of the industrial glue, the release paper is uncovered and removed while using, a coating weight of the glue 3 for sticking pests is 0.001-30 g/cm²); the lure 4 containing tobacco pest pheromones is located on the internal surface of the bottom plate 1 or the face plate 2 within the trapping cavity 11 (that is to say, the lure 4 is adapted for releasing tobacco insect attractant, and the glue 3 for sticking pests and the lure 4 are located within the trapping cavity 11).

To improve the observation and identification effect, the face plate is able to be made of magnifying lens materials (including PVC plastics, Acrylic plastics, ABS plastics and glass) with the function of increasing visual angle.

The face plate 2 has a shape of flaky planar polygon, a shape of the bottom plate 1 is similar to that of the face plate 2, the face plate 2 is able to be bent to an arched plate and made of transparent materials.

Two bottom plate block buttons (namely, a bottom plate upper block button 6 and a bottom plate lower block button 8) for mounting the face plate 2 are respectively located at a middle portion of an upper edge and a lower edge of the bottom plate 1. The bottom plate 1 and the face plate 2 are designed to be independent from each other. Two face plate block buttons (namely, a face plate upper block button 5 and a face plate lower block button 7) for engaging with the two bottom plate block buttons are respectively located at a middle portion of an upper edge and a lower edge of the face plate 2 which is opposite to the bottom plate 1. While using, the release paper on the glue for sticking pests is uncovered, and then the face plate 2 is bent to respectively engage the two face plate block buttons with the two bottom plate block buttons.

Applications: The trap of the present invention is placed at an area where tobacco pests may appear for regularly observing and recording an amount of the trapped tobacco pests. There is no need to manually open the face plate of the trap for counting, no protective box is needed, observation is intuitive, counting is accurate (after several verification, the trap comprising the face plate made of transparent materials has an improved trapping effect over 30% than the conventional trap made of non-transparent materials, and has an increased counting accuracy for trapping the pests to 98%-100%).

### Embodiment 2

The embodiment 2 is basically identical with one of the embodiments 1, 3 and 4. Differences are as follows: the face plate is made of non-transparent sheet materials; an observation hole is provided on the face plate, is inserted into or configured to attaching a transparent dust-proof board 9 for observing an amount of the trapped pests; the transparent dust-proof board 9 is made of transparent materials or magnifying lens materials with image zoom function (as shown in FIG. 3).

Applications: The trap of the present invention is placed at an area where tobacco pests may appear. No manual operation and protective box are needed, observation is intuitive, counting is accurate (after several verification, the trap comprising the face plate made of transparent materials has an improved trapping effect over 30% than the conventional trap made of non-transparent materials, and has an increased counting accuracy for trapping the pests to 98%-100%).

### Embodiment 3

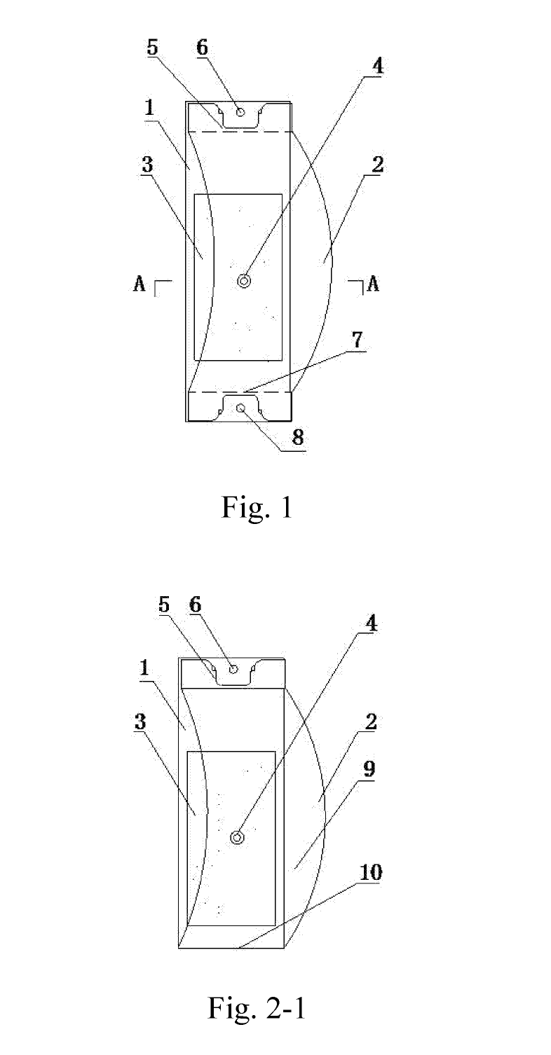

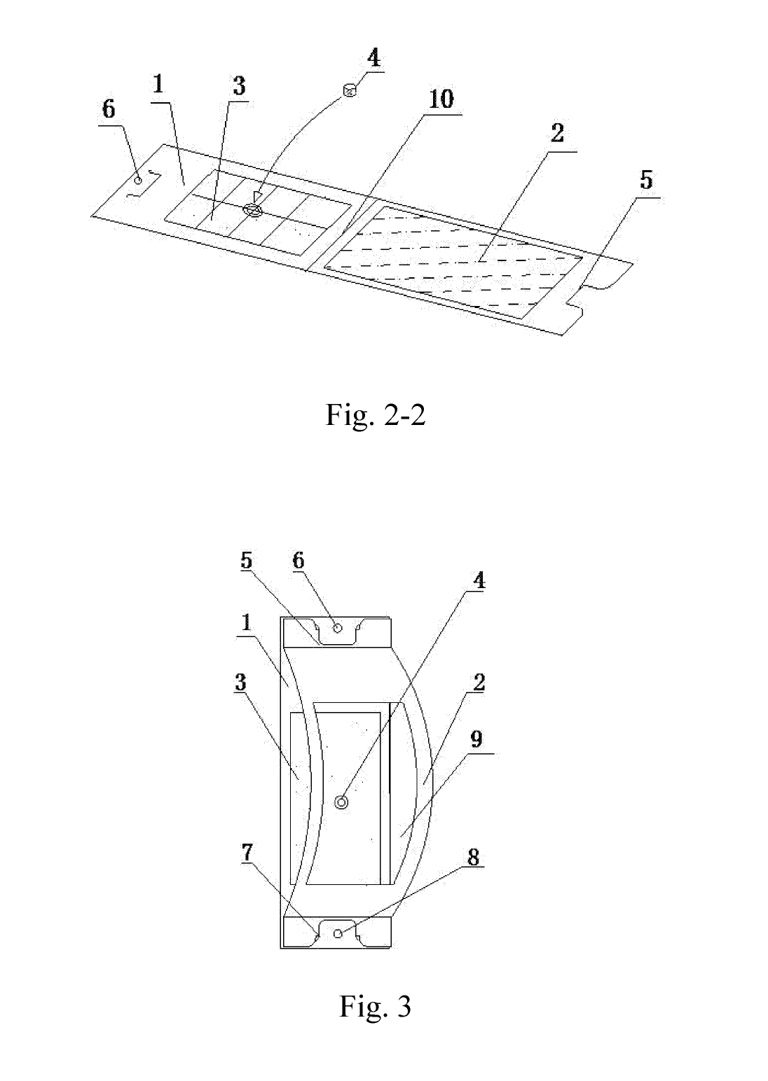

Referring to FIGS. 2-1 and 2-2 (an integrated trap), a stick-trap type trap for tobacco pests comprises a bottom plate 1, a face plate 2, a glue 3 for sticking pests and a lure 4 containing tobacco pest pheromones.

The bottom plate 1 and the face plate 2 are integrated (namely, the bottom plate 1 and the face plate 2 are directly designed to be a whole, or the bottom plate 1 is bonded or hotly combined with the face plate 2 to be a whole), a broken line 10 is provided at a middle of an integrated structure formed by the bottom plate 1 and the face plate 2. Meanwhile, two block buttons (namely, a bottom plate upper block button 6 and a face plate upper block button 5) are respectively located at a middle portion of an upper edge of the bottom plate 1 and the face plate 2. While using, the release paper on the glue 3 for sticking pests is uncovered and removed, and then the face plate upper block button 5 is engaged with the bottom plate upper block button 6 (the face plate is located above and engaged with the bottom plate).

A trapping cavity 11 is formed between the face plate 2 and the bottom plate 1. A side face of the trapping cavity 11 (which can be a left side face, a right side face, or both) is communicated with a surrounding environment of the trap (wherein the side face is an opening end, such as holes, cracks and gaps, which is convenient for allowing the tobacco pests to enter the trapping cavity). The glue 3 for sticking pests is coated on an internal surface of the bottom plate 1 opposite to the face plate 2 (namely, the glue 3 for sticking pests is coated on the internal surface of the bottom plate 1; a layer of release paper is attached on the glue 3 for sticking pests; the release paper is removed while using, a coating weight of the glue 3 for sticking pests is 0.001-30 g/cm²); the lure 4 containing tobacco pest pheromones is located on the internal surface of the bottom plate 1 (namely, the lure 4 for releasing tobacco insect attractant and containing tobacco pest pheromones is located on the glue 3 for sticking pests; the glue 3 for sticking pests and the lure 4 are located within the trapping cavity 11). The face plate 2 is made of transparent materials ((including PVC plastics, Acrylic plastics, ABS plastics and glass). To improve the observation and identification effect, the face plate is also able to be made of magnifying lens materials with the function of increasing visual angle. The face plate 2 has a shape of flaky planar polygon, a shape of the bottom plate 1 is similar to that of the face plate 2, the face plate 2 is able to be bent to an arched plate, the bottom plate 1 is also able to be made of transparent materials.

Applications: The trap of the present invention is placed at an area where tobacco pests may appear. No manual operation and protective box are needed, observation is intuitive, counting is accurate (after several verification, the trap comprising the face plate made of transparent materials has an improved trapping effect over 30% than the conventional trap made of non-transparent materials, and has an increased counting accuracy for trapping the pests to 98%-100%).

### Embodiment 4

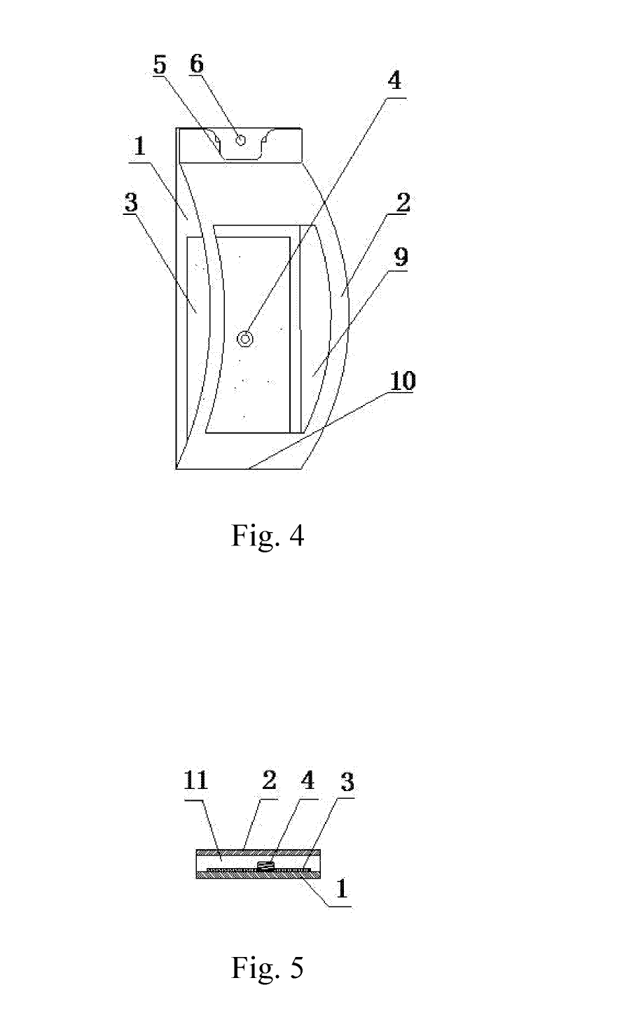

Referring to FIG. 4 (an integrated trap comprising a face plate made of non-transparent flaky materials), a stick-trap type trap for tobacco pests comprises a bottom plate 1, a face plate 2, a glue 3 for sticking pests and a lure 4 containing tobacco pest pheromones.

The face plate 2 is a flaky arched plate. The bottom plate 1 and the face plate 2 are integrated (namely, the bottom plate 1 and the face plate 2 are directly designed to be a whole, or the bottom plate 1 is bonded or hotly combined with the face plate 2 to be a whole), a broken line 10 is provided at a middle of an integrated structure formed by the bottom plate 1 and the face plate 2, the integrated structure is folded in half with respect 1( )to the broken line 10 (a rear edge is provided after the broken line 10). Meanwhile, two block buttons (namely, a bottom plate upper block button 6 and a face plate upper block button 5) are respectively located at a middle portion of an upper edge of the bottom plate 1 and the face plate 2. While using, the release paper on the glue 3 for sticking pests is uncovered and removed, and then the face plate upper block button 5 is engaged with the bottom plate upper block button 6 (the face plate is located above and engaged with the bottom plate).

A trapping cavity 11 is formed between the face plate 2 and the bottom plate 1. A side face of the trapping cavity 11 (which can be a left side face, a right side face, or both) is communicated with a surrounding environment of the trap (wherein the side face is an opening end convenient for allowing the tobacco pests to enter the trapping cavity). The glue 3 for sticking pests is coated on an internal surface of the bottom plate 1 opposite to the face plate 2 (namely, the glue 3 for sticking pests is coated on the internal surface of the bottom plate 1; a layer of release paper is attached on the glue 3 for sticking pests; the release paper is removed while using, a coating weight of the glue 3 for sticking pests is 0.001-30 g/cm²); the lure 4 containing tobacco pest pheromones is located on the internal surface of the bottom plate 1 (namely, the lure 4 for releasing tobacco insect attractant and containing tobacco pest pheromones is located on the glue 3 for sticking pests; the glue 3 for sticking pests and the lure 4 are located within the trapping cavity 11).

The face plate 2 is made of non-transparent flaky materials, and the bottom plate 1 is also able to be made of non-transparent flaky materials. An observation hole is provided at a middle portion of the face plate 2. A transparent dust-proof board 9, made of transparent materials or magnifying lens materials, is inserted into the observation hole for observing an amount of trapped pests.

Applications: The trap of the present invention is placed at an area where tobacco pests may appear. No manual operation and protective box are needed, observation is intuitive, counting is accurate (after several verification, the trap comprising the face plate made of transparent materials has an improved trapping effect over 30% than the conventional trap made of non-transparent materials, and has an increased counting accuracy for trapping the pests to 98%-100%).

### Embodiment 5

The embodiment 5 is basically identical with any one of the embodiments 1-4. Differences are as follows: a dust-proof baffle is provided at a side of the face plate. Holes, cracks or gaps are provided on the dust-proof baffle. Cracks or gaps are provided between the dust-proof baffle and the bottom plate.

The dust-proof baffle is able to be made of materials which are same as the face plate and is integrated with the face plate. While using, the dust-proof baffle is bent towards the bottom plate along a connection of the dust-proof baffle and the face plate.

### Embodiment 6

The embodiment 6 is basically identical with any one of the embodiments 1-5. Differences are as follows: the face plate is spherical (such as hemispherical).

### Embodiment 7

The embodiment 7 is basically identical with any one of the embodiments 1-5. Differences are as follows: the face plate is spherical (such as hemispherical).

While applied to tobacco circulation and manufacturing link, the present invention is placed at regions where the tobacco pests breed and take actions, and is away from sunlight, heat, vibration, air flow or dust production areas as far as possible.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A stick-trap type trap for tobacco pests, comprising: a bottom plate (1), a face plate (2), a glue (3) for sticking pests and a lure (4) containing tobacco pest pheromones;
wherein both the bottom plate and the face plate are made of bendable plastic sheet or Kraft Linerboard (KLB) with a weight index of over 120 g/m², the face plate (2) is bent for engaging with the bottom plate (1) to form a trapping cavity (11) with a side face which is communicated with a surrounding environment of the trap, the glue (3) for sticking pests is coated on an internal surface of the bottom plate (1) which is located within the trapping cavity (11) and is opposite to the face plate (2), the lure (4) containing tobacco pest pheromones is located on the internal surface of the bottom plate (1) or the face plate (2) which are located within the trapping cavity (11);
wherein the face plate is made of materials as follows:
(A) the face plate is made of transparent materials;
(B) the face plate is made of non-transparent KLB materials, an observation hole is provided on the face plate, a transparent dust-proof board (9) is inserted into or attached to the observation hole for observing an amount of trapped pests, the transparent dust-proof board (9) is made of transparent plastics or glass material.

2. The stick-trap type trap, as recited in claim 1, wherein the face plate is made of materials as follows:
(A) the face plate is made of magnifying lens materials with image zoom function;
(B) the face plate is made of non-transparent KLB materials, the observation hole is provided on the face plate, the magnifying lens materials with image zoom function are inserted into or attached to the observation hole.

3. The stick-trap type trap, as recited in claim 1, wherein a bottom plate upper block button and a bottom plate lower block button for mounting the face plate are respectively located at a middle portion of an upper edge and a lower edge of the bottom plate, a face plate upper block button and a face plate lower block button for engaging with the bottom plate upper block button and the bottom plate lower block button are respectively located at a middle portion of an upper edge and a lower edge of the face plate which is opposite to the bottom plate; while using, the face plate is bent to respectively engage the bottom plate upper block button and the bottom plate lower block button with the face plate upper block button and the face plate lower block button.

4. The stick-trap type trap, as recited in claim 1, wherein the bottom plate and the face plate are designed to be an integrated structure which is capable of folding in half along a middle of the integrated structure; a broken line is provided at the middle of the integrated structure; the integrated structure is folded in half along the broken line; a bottom plate upper block button and a face plate upper block button are respectively located at a middle portion of an upper edge of the bottom plate and the face plate at this time; while using, the face plate is bent to engage the face plate upper block button with the bottom plate upper block button.

5. The stick-trap type trap, as recited in claim 1, wherein a planar polygon shape of the face plate is similar to that of the bottom plate.

6. The stick-trap type trap, as recited in claim 1, wherein the glue for sticking pests are coated on the internal surface of the bottom plate, and a coating weight of the glue for sticking pests is 0.001-30 g/cm².

7. The stick-trap type trap, as recited in claim 1, wherein the face plate is a flaky arched plate, a planar convex plate, or a spherical plate.
